(19) United States
(12) Patent Application Publication
(10) Pub. No.: US 2026/0163153 A1
(43) Pub. Date: Jun. 11, 2026

(54) PROTECTIVE STRUCTURE OF AN ELECTRIC BATTERY AND A MOTOR VEHICLE COMPRISING SUCH A PROTECTIVE STRUCTURE

(71) Applicant: FLEXIS, BOULOGNE-BILLANCOURT (FR)

(72) Inventors: Christophe HANOUEL, GUYANCOURT (FR); Nicolas WISS, CHEVREUSE (FR)

(21) Appl. No.: 19/415,473

(22) Filed: Dec. 10, 2025

(30) Foreign Application Priority Data
Dec. 10, 2024 (FR) FR2413776

(51) Int. Cl. H01M 50/242; B60R 16/023; B60R 16/04; H01M 50/238; H01M 50/249; H01M 50/262; H01M 50/60; H01M 50/682

(52) U.S. Cl. CPC H01M 50/242; B60R 16/0239; B60R 16/04; H01M 50/238; H01M 50/249; H01M 50/262; H01M 50/668; H01M 50/682; H01M 2220/20

(57) ABSTRACT

A protective structure of an electric battery in a motor vehicle having a longitudinal axis, a transverse axis, and a vertical axis. The protective structure includes a support crossmember and a protector together defining a housing for accommodating an electric battery. The protector includes at least a first defense flange configured to deform by dissipating energy under the application of a force along the longitudinal axis. The protector also includes an upper connecting strip connected at least to the first defense flange. The protective structure also includes at least four screwed fastenings to connect the protector to the support crossmember, the defense flange having a first dimension along the longitudinal axis, at least 10% greater than the dimension of the electric battery along the longitudinal axis.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a protective structure of an electric vehicle battery. This protective structure is intended to protect the mechanical integrity of the battery, particularly in the event of a frontal accident involving the vehicle.

In particular, motor vehicles that have a front overhang are of interest here.

### BACKGROUND

The battery in question here is a service battery that powers a number of electronic devices and must remain functional after an accident, particularly a frontal impact. Maintaining the battery's functionality, in particular, allows the operation of door unlocking, vehicle hazard lights, emergency call functionality, etc.

The term ‘crash’ has become established in the industry and in common language as equivalent to an accidental impact situation.

Particularly, the term “crash-test” refers to an accidental impact test conducted on a vehicle under predefined conditions. There is a series of reference crash tests, some of which are of particular interest in the context of this document.

In known vehicle configurations, if the electric battery is located in the front engine compartment, it is not directly exposed to penetration by another mechanical element of the vehicle or even a foreign body. Indeed, the sufficiently large front overhang allows the battery to be housed away from areas severely damaged by reference crash tests.

In other known vehicle configurations, the electric battery is located in another part of the vehicle, less vulnerable to the consequences of a frontal impact.

Furthermore, a type of vehicle, or more broadly a vehicle technical platform, must be developed with a left-hand drive version, i.e., with the steering wheel placed to the left of a vertical median plane of the vehicle, and with a right-hand drive version, i.e., with the steering wheel placed to the right of the vertical median plane of the vehicle.

The protection of the service battery must be ensured for both the left-hand drive version and the right-hand drive version.

### SUMMARY

The inventors have sought to propose a solution that enables the service battery to be placed in the front engine compartment, in a reduced front overhang configuration, with the solution enabling avoiding substantial damage to the service battery during reference crash tests. Optionally, the solution sought could be suitable for both right-hand drive and left-hand drive vehicles.

To this end, a protective structure for an electric battery in a motor vehicle having a longitudinal axis, a transverse axis, and a vertical axis is proposed here, with the protective structure comprising a support crossmember and a protector together defining a housing for accommodating an electric battery, the protector comprising at least a first defense flange, intended to deform by dissipating energy under the application of a crash force along the longitudinal axis, the protector comprising an upper connecting strip connected at least to the first defense flange, the protective structure comprising at least four screwed fastenings to connect the protector to the support crossmember, with the defense flange having a first dimension along the longitudinal axis at least 10% greater than the dimension of the electric battery along the longitudinal axis.

Expressed in another formulation, the first defense flange forms a small beam with a length typically between 20 cm and 30 cm (longer than the X dimension of the battery), with this beam forming a shock absorber element, protecting the battery in the frontal impact configuration. The first defense flange can be described as ‘lateral’ because it is located near a lateral wall of the battery. The first defense flange extends particularly along the longitudinal axis, and it is in this direction that the crushing occurs, enabling energy absorption.

It turns out that in the absence of such a protective element the battery is substantially damaged, in a vehicle configuration with a low-value front overhang, particularly by the ‘barrier’ crash test at 56 km/h or the ‘pole’ crash test, and the electrical functions supported by the service battery may no longer be ensured from the moment of the crash.

By means of the present disclosure, a configuration of a motor vehicle with a reduced front overhang, typically less than 850 millimeters, is obtained, with a service battery installed in the front engine compartment, with this service battery protected by the proposed protective structure, at least for a subset of reference crash tests.

It is also noted that the first defense flange comes to rest, by moving back under the effect of the crash, on an element of the vehicle's bulkhead, which is a structural element of the vehicle that separates the passenger compartment from the front engine compartment. In other words, the defense flange bottoms out on a stop X and then is crushed along X.

The term “defense flange” expresses the defense and protection function provided to the electric battery against potential mechanical aggressions coming from the front of the vehicle, caused by the consequences of a frontal impact. One could just as well have used the term “defense frame” or “defense/protection beam.”

Regarding the “front engine compartment” terminology, this term is used regardless of the type of engine, e.g., thermal, hybrid, or electric.

It is noted that the service battery can be of the lead type or the lithium-ion type, and more generally, the battery can be of any electrochemical type.

According to one advantageous embodiment, the protector may further comprise a second defense flange intended to deform by dissipating energy under the application of a crash force along the longitudinal axis, the first and second defense flanges framing the electric battery along the transverse axis.

Thus, the battery is protected on both sides (left and right); the symmetry of the protection is improved. Moreover, the energy absorbed by the deformation of the two defense flanges is increased.

In practice, the housing is delimited on the right and left by the first and second defense flanges. It is noted that the housing is generally prismatic and parallelepiped. It is also noted that the housing leaves a free space in front of the battery, as will be explained in more detail later.

The two defense flanges are parallel to each other. They generally extend in an XZ plane.

In this configuration, the upper connecting strip is connected to both the first defense flange and the second defense flange.

According to one embodiment, along the vertical axis, the height of the first and second defense flanges is at least equal to 60% of the height of the service battery, preferably at least 70% of the height of the battery.

According to one embodiment, in the area of the service battery's electrical terminals, the first and second defense flanges remain lower than the electrical terminals of the service battery. The risk of contact between the protector and the electrical terminals is thus reduced, even in the event of local deformations.

According to one embodiment, the upper connecting strip does not cover the electrical terminals of the service battery. As mentioned previously, here too, the risk of contact between the protector and the electrical terminals is thus reduced, even in the event of local deformations.

According to one embodiment, the protective structure may further comprise a front plate connecting the front edges of the first and second defense flanges.

By means of this, the entire front face of the service battery can be protected from specific mechanical aggression(s). The lateral faces and the front face are delimited by protective plates of the protector.

It turns out that this front plate prevents any perforation of the battery, which is a determining criterion in the case where the service battery is of the lithium-ion type.

According to one embodiment, the height of the front plate is identical or similar to the height of the first and second lateral defense flanges. Alternatively, the front plate may have a greater height than the height of the lateral defense flanges.

According to one embodiment, the protective structure further comprises a liquid retention tray.

The presence of the tray is compatible with the configuration of the protective structure. The tray is located essentially under the battery and comprises rising edges. The fastenings of the protector pass through the mounting tabs of the tray, or even directly through the tray itself, to be screwed into the support crossmember.

According to one embodiment, the protector is a single-piece metal sheet manufactured by cutting and folding from a thick sheet of metal, with a thickness of between 2 mm and 2.5 mm.

It is therefore an easy-to-manufacture piece with an available process and a reasonable cost.

Furthermore, it may be provided with folds forming reinforcing ribs. These reinforcing ribs advantageously extend along the longitudinal axis X.

According to one embodiment, a predetermined minimum distance is provided, separating the positive and negative terminals of the service battery from the closest element of the protector. A value of 25 mm can be chosen for the predetermined minimum distance.

This minimum distance prevents undesirable contact of one of the battery terminals with an external metallic element, particularly the positive terminal, which would cause a short circuit.

According to one embodiment, the four (or more) fastenings fix both the protector and the retention tray on the support crossmember, and/or on a vehicle body element.

In other words, the same fastenings clamp the protector and the tray. Thus, the addition of the protector does not lead to an increase in the number of fastenings.

According to one embodiment, the upper connecting strip comprises attachment elements for fixing a fuse box. By means of this, the protector integrates additional functions to the purely protective function, to fix auxiliary elements such as a primary fuse box or a circuit breaker, a plastic terminal cover, or any other element connected to the electrical distribution head that starts from the service battery.

The present disclosure also aims at a motor vehicle, having a longitudinal axis, a transverse axis, and a vertical axis, preferably electric or hybrid, with a front overhang of less than 850 mm, the vehicle comprising an electric service battery arranged in a front overhang area, the vehicle comprising a protective structure as described above.

Advantageously, the protective structure thus allows the service battery to be placed in the front engine compartment, while the low value of the front overhang makes this position a priori unfavorable.

The present disclosure also aims at an assembly comprising at least a first motor vehicle as described above and a second motor vehicle as described above, the first motor vehicle being of the left-hand drive type and the second motor vehicle being of the right-hand drive type, characterized in that the position of the electric service battery is identical for the first and second vehicles.

By means of this, a unique service battery position is achieved, regardless of the position of the steering wheel, whether on the right or left, which allows rationalizing the diversity of parts and reducing the design time.

### BRIEF DESCRIPTION OF THE DRAWINGS

The present disclosure will be further detailed by the description of non-limiting embodiments, and based on the appended figures illustrating variants of the present disclosure, wherein:

FIG. 1 schematically represents a side view of a front area of a vehicle with a low-value overhang;

FIG. 2 schematically represents a front view of the front area of the vehicle in FIG. 1;

FIG. 3 schematically represents a perspective view of a battery protected by an example of a protective structure according to the present disclosure;

FIG. 4 schematically represents a perspective view of another example of a protective structure;

FIG. 5 schematically represents a side view of a service battery and the protector that protects it, in a normal state;

FIG. 6 is similar to FIG. 5 and represents the service battery and the protector in a state after a crash;

FIG. 7 schematically represents the battery tray and fastenings;

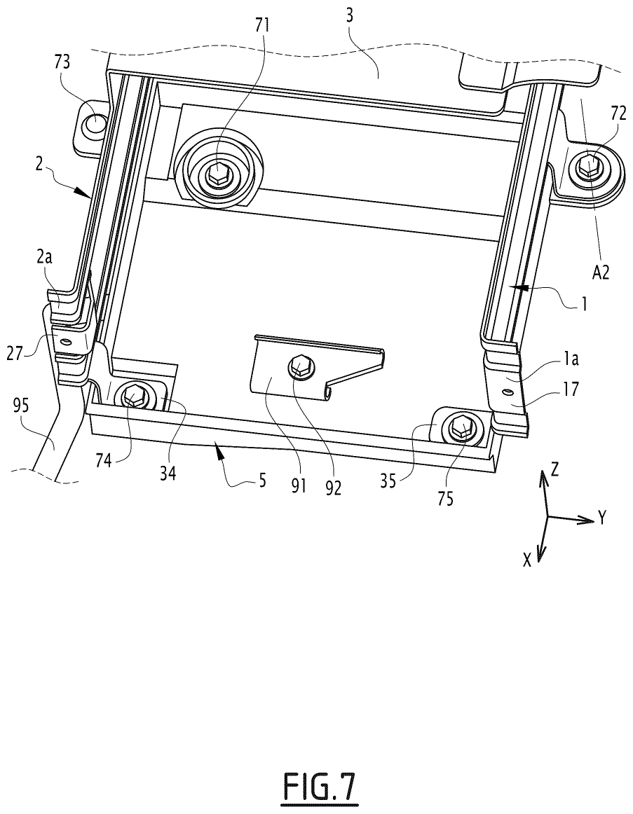

FIG. 8 represents a fuse box mounted on the upper connecting strip;

FIG. 9 represents a top view of the battery area before the crash and after the crash.

### DETAILED DESCRIPTION

In the various figures, the same references designate identical or similar elements. For clarity of the presentation, some elements are not necessarily represented to scale.

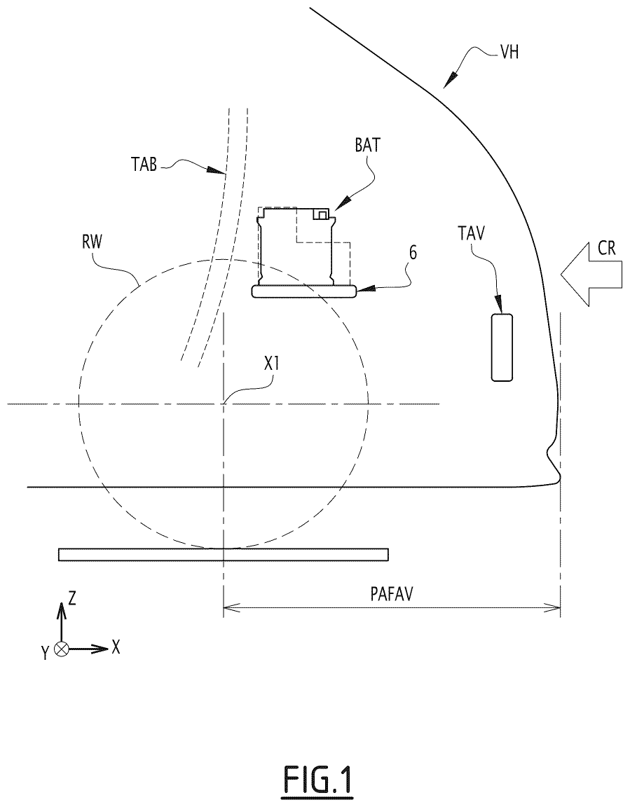

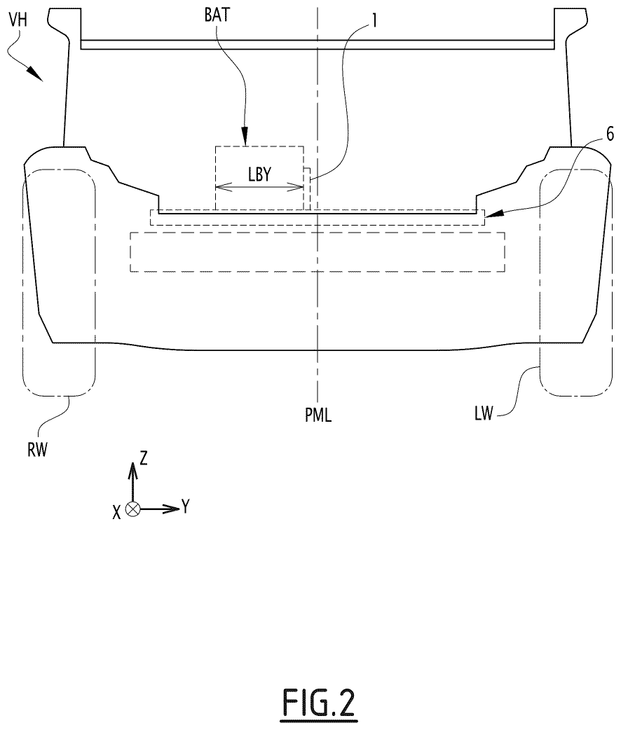

FIGS. 1 and 2 show a front part of a motor vehicle VH. The motor vehicle in question is here a utility vehicle. It may be, a van, a truck or a minibus, for example.

Regarding the spatial positioning of vehicle elements, as is customary in the industry, the X direction corresponds to the vehicle's longitudinal direction, the Z direction corresponds to the vertical direction relative to the local ground and the Y direction, perpendicular to the two previous ones, corresponds to the vehicle's transverse direction.

The terms ‘front’and ‘rear’are appreciated relative to the longitudinal direction X, considering that the front corresponds to the usual movement of the vehicle. The terms ‘top’ and ‘bottom’ are relative to the vertical direction Z.

The terms ‘left’ and ‘right’ are appreciated relative to the transverse direction Y when looking in the longitudinal direction towards the front.

The vehicle in question has an overall height of at least 160 cm, most often at least 170 cm.

The vehicle VH comprises a front engine compartment, which contains a powertrain element of the vehicle's front axle; this powertrain element can be a thermal engine, a hybrid powertrain or a pure electric motor.

The vehicle VH is characterized by a front overhang, noted PAFAV, of low value. Generally, the front overhang PAFAV is less than 850 mm. Preferably, the front overhang PAFAV is less than 800 mm. In particular configurations of interest, the front overhang PAFAV is around 750 mm.

As a reminder, with reference to FIG. 1, the front overhang is defined by the distance in X that separates the X1 axis of the front axle wheels from the most anterior part of the vehicle, i.e., located furthest forward.

In the configuration of interest, it is understood that the engine compartment has a fairly generous space in the vertical direction Z but a very constrained space in the longitudinal direction X.

Furthermore, concerning a utility vehicle, all the loading space posterior to the driving compartment is generally dedicated to a useful loading volume and, as a result, having to place bulky elements such as the service battery in a space posterior to the driving compartment is to be avoided. It is noted that it is possible to have the traction battery (main battery in a zero-emission mode vehicle) placed in the vehicle's floor, i.e., under the useful loading volume.

It is therefore necessary to deal with a constraint of placing the service battery, identified as BAT, in the front engine compartment.

FIGS. 1 and 2 illustrate the position of the vehicle's bulkhead, identified as TAB, which separates the front engine compartment from the driving compartment (also driving ‘cabin’ for some utilities where the loading volume is separated from the driving compartment).

The vehicle is equipped with a front crossmember TA that extends transversely in a position just behind the bumper. This front crossmember TA is structurally connected to right and left beams, as known and therefore not described in detail here. The front crossmember TA is one of the essential contributors to protection in the front accidental impact configuration.

The impact of the front crash is identified as CR in FIGS. 1, 4, and 9.

The vehicle's front axle comprises a left wheel, noted LW, and a right wheel, noted RW.

The service battery BAT rests on a support crossmember 6. The support crossmember 6 is a metal piece that extends transversely, i.e. generally in the Y direction from one side to the other, connected to body elements belonging to the vehicle.

The support crossmember 6 acts as a shelf on which accessory elements of the vehicle systems are placed, particularly the thermal management system. Some accessory elements are fixed under the support crossmember. The support crossmember 6 is described as a multifunction crossmember.

Regarding the service battery BAT, it rests on the support crossmember 6, in a position to the right of the vertical longitudinal median plane PML (Y=0), as visible in FIG. 2.

The service battery BAT comprises a positive terminal B+and a negative terminal B-on the upper part.

The positive and negative terminals are generally aligned in the transverse direction Y. The terminals are located on the front side.

From another point of view, given the compactness requirement in X, the smallest dimension of the battery (noted here as LBX) is aligned on the longitudinal axis X. LBX can be between 160 mm and 180 mm.

The length of the battery, directed in the transverse direction Y, is noted as LBY. LBY is generally greater than LBX.

The height of the battery is noted as HB.

Advantageously, according to the present disclosure, the battery benefits from a protective structure that preserves its integrity in the event of a frontal impact suffered by the vehicle.

The protective structure is based on the support crossmember 6, already described.

Furthermore, a protector 10 is provided, which will be described in the following paragraphs.

In the illustrated example, the protector comprises a first defense flange 1, located to the left of the battery, and a second defense flange 2 located to the right of the battery. The first and second defense flanges frame the battery in the transverse direction Y. The first and second defense flanges are not necessarily in contact with the battery's lateral walls, but they are at a short distance from the battery's lateral walls, say a few millimeters.

Indeed, advantageously, it is possible to remove the battery without removing the protector 10, and it is also possible to install a new battery without removing the protector.

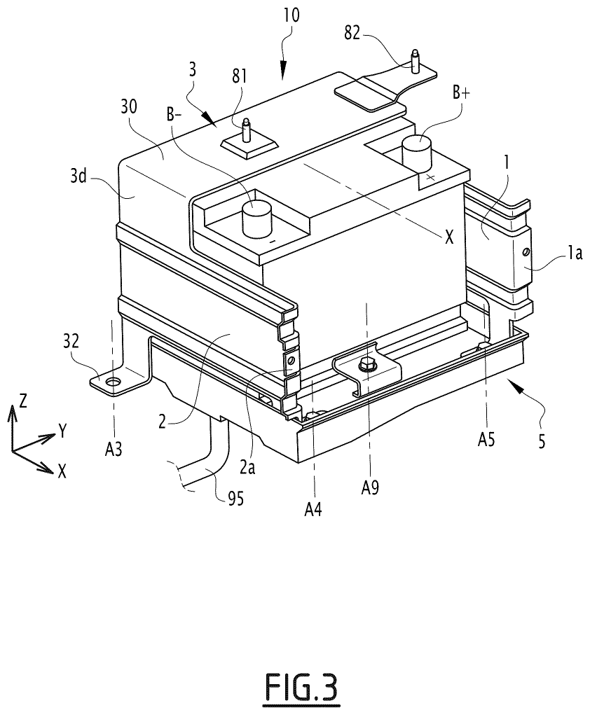

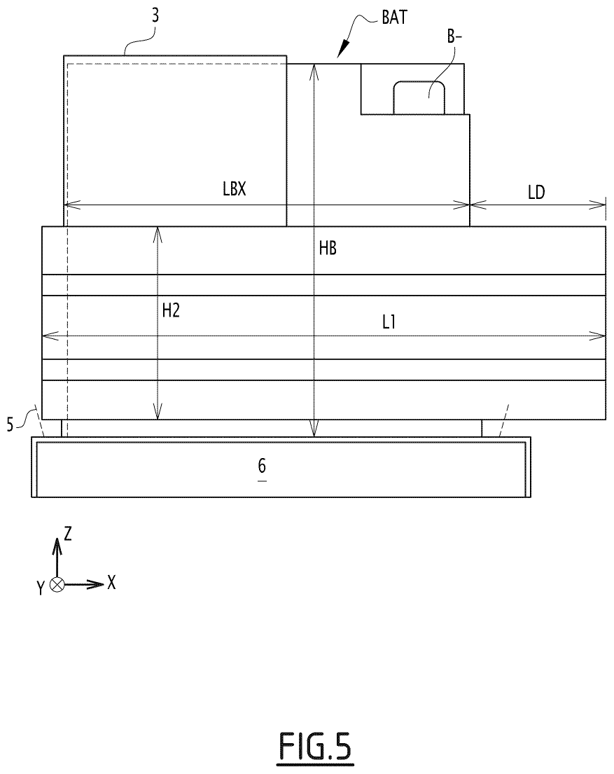

The height H2 of the flanges is less than the height HB of the battery, as visible in FIGS. 3 and 5.

For example, the height of the first and second defense flanges is at least equal to 60% of the height of the service battery, preferably at least 70% of the height of the battery, but remains less than 80% of the height of the service battery.

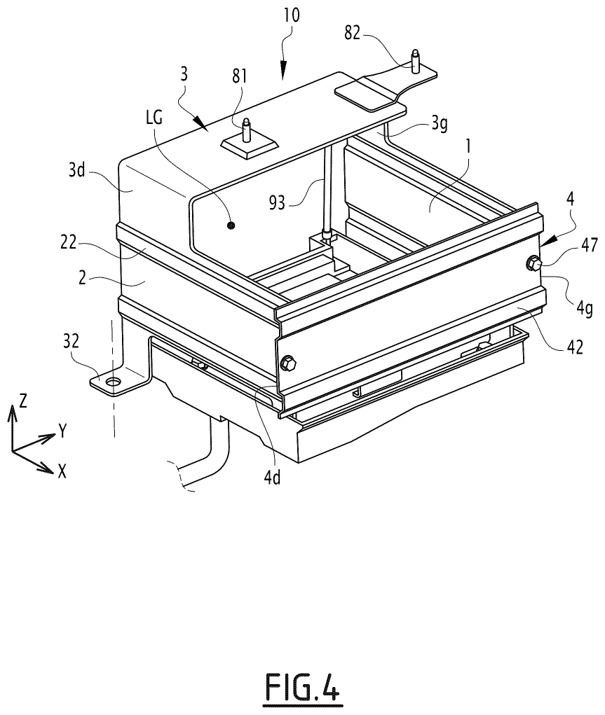

As visible in FIGS. 3 and 4, the lower limit in Z of each defense flange does not necessarily coincide with the lower limit of the battery, as indeed a recovery tray is planned in the lower part of the battery, which will be discussed below.

Thus, the lower limit of each defense flange can be at a vertical level above the lower limit of the service battery.

Furthermore, an upper connecting strip 3 is provided, which is connected to both the first defense flange 1 and the second defense flange 2.

To do this, the upper connecting strip comprises vertical flaps. A left vertical flap, noted 3g, and a right vertical flap, noted 3d, are thus provided.

The upper connecting strip 3 adjoins the upper face of the battery. The upper connecting strip provides an enveloping effect and prevents any overturning of the battery under impact.

It is noted that the upper connecting strip does not directly participate in protection against crushing along X, but it helps maintain the defense flanges in the appropriate position during the initial impact until the flanges are contacted by the front crossmember or another element that comes to crush them in X.

In one example, the protector 10 is a single-piece metal sheet manufactured by cutting and folding from a thick sheet of metal, with a thickness of between 2 mm and 2.5 mm.

The thickness is determined by the expected resistance of the defense flanges to crushing in X.

The left defense flange 1 comprises a front edge 1a. The right defense flange 2 comprises a front edge 2a. Each front edge comprises a bent return forming a vertical front strip that extends in the YZ plane. We will see the interest of this later.

It is possible to provide one or more stiffening ribs 22 on each defense flange in X.

It is noted that it is possible to add a lining to the defense flanges, in addition or as an alternative to the ribs.

The protector 10 is equipped with rear tabs 32 that comprise a horizontal flat spot with a hole that enables screw fixing onto the support crossmember 6. It is noted that the rear tabs 32 extend outward in the transverse direction relative to the battery housing.

Furthermore, the protector 10 is equipped with front tabs 34,35, that each also comprise a horizontal flat spot with a hole for receiving a screw fixing onto the support crossmember 6. It is noted that the rear tabs 32 extend inward in the transverse direction relative to the battery housing.

The support crossmember 6 and the protector 10 together define a housing LG for accommodating a battery.

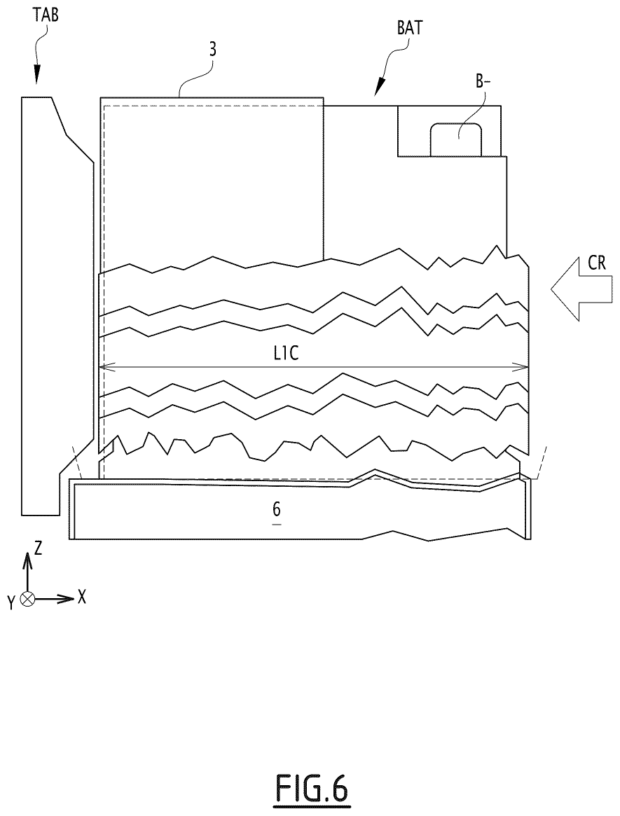

As illustrated in FIG. 5, the normal length of each defense flange is noted as LC. As illustrated in FIG. 6, after crushing as a result of a frontal impact, the length of each defense flange is reduced to L1C. The deformation related to the reduction in length allows significant energy absorption and provides protection for the mechanical integrity of the electric battery.

In the normal state, the defense flanges 1,2 protrude forward relative to the front face of the battery by a dimension LD, as visible in FIG. 5. There may also be a rearward protrusion.

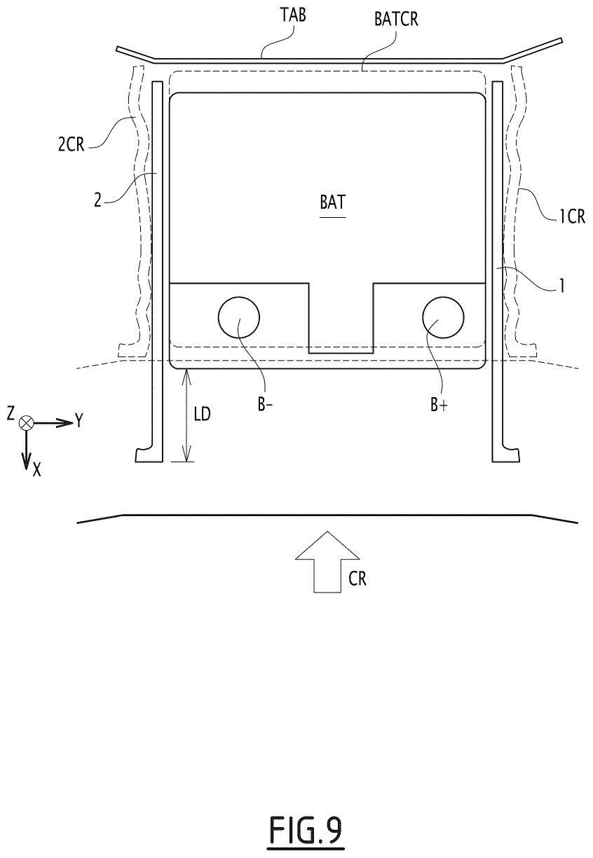

In the event of an impact, the protrusion of dimension LD is reduced to a small value, or even to 0 (see FIGS. 6 and 9).

It is noted that there is no rear face in the protector in one embodiment. This is made possible in the absence of mechanically aggressive elements placed behind the battery.

In addition to the protector, a liquid effluent retention tray is provided. This tray noted 5 is made of plastic material; it marginally contributes to the mechanical protection of the battery.

The tray comprises a low depression forming a sump to collect liquid effluents that may have escaped from the battery and direct them via a conduit 95 to the ground.

Furthermore, a gas effluent evacuation conduit 93 is also provided, exiting from the top of the battery to the recovery tray 5.

In the illustrated example, the protector 10 is fixed to the support crossmember by 4 fastenings, namely a left rear fastening 72 with axis A2, a right rear fastening 73 with axis A3, a right front fastening 74 with axis A4, and a left front fastening 75 with axis A5.

An inner fastening 71 is also provided, which serves to fix the tray to the support crossmember. Furthermore, a screw 92 and a metal plate 91 are provided, as known per se for maintaining the battery in place. The screw 92 is screwed into a tapped hole with axis A9 provided in the support crossmember 6.

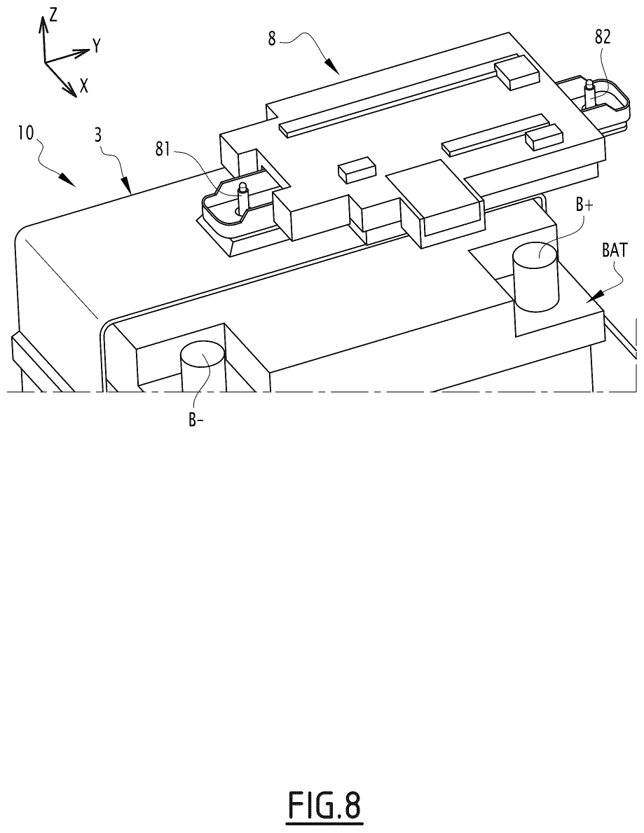

Furthermore, on the upper connecting strip 3, means for fixing a fuse box are arranged. More specifically, in the illustrated example, a first welded stud 81 and a second welded stud 82 are provided, forming attachment elements (81,82) for fixing a fuse box, identified as 8 as shown in FIG. 8.

In an optional embodiment, the protector is complemented by a front plate 4, connecting the front edges of the first and second defense flanges.

This front plate 4 can be installed or not, depending on the type of battery to be protected. According to one embodiment, such a front protection plate is installed when the service battery is of the lithium type.

More specifically, the front plate 4 comprises a left border 4g assembled to the front edge 1 a of the left defense flange, and a right border 4d assembled to the front edge 2a of the right defense flange 2.

The front edge 1 a comprises a vertical front strip 17 that receives the left border 4g of the front plate 4 flat. The front edge 2a of the other flange also comprises a vertical front strip 27 that receives the right border 4d of the front plate 4 flat.

The vertical front strips 17,27 on each side enable the forces transmitted by the front plate 4 to the defense flanges 1 and 2 to be equalized, in the event of an impact.

The assembly can be done simply by screws 47 as in the illustrated example, but any other preferably removable assembly means can be used.

It is noted that the front plate 4 must be removed to be able to remove the electric battery.

Furthermore, the front plate 4 can be equipped with stiffeners 42.

In addition, or as an alternative, the front plate 4 can be formed as a one-piece lining, i.e. two folded sheets assembled to each other by welding.

The protector 10, and the front plate 4 when present, are made of steel with a significant yield strength, preferably high yield strength steel.

According to one option, the anti-corrosion treatment applied to other body and chassis parts is applied to the protector and the front plate.

In FIG. 9, the nominal situation is illustrated in solid lines in a top view, and the situation after a frontal impact is also illustrated in dashed lines, with the first defense flange 1 crushed and shortened (reference 1CR) along X, the second defense flange 2 crushed and shortened (reference 2CR) along X, the battery having moved back slightly to the position BATCR.

Regarding the dimensioning of the protrusion length LD, the latter can be expressed in absolute terms; for example, LD can be between 35 mm and 55 mm. Alternatively, the protrusion length LD can be expressed in relative value. For example, LD can be between 10% of LBX and 15% of LBX.

Depending on configurations and crash test trials, it may turn out that the presence of a single defense flange, particularly the left flange, is sufficient to provide the desired protection for the service battery.

Thus, the battery is protected by the presence of at least one defense flange; it is not always necessary to have both flanges on either side of the battery as illustrated in the figures and discussed above.

A first left-hand drive motor vehicle and a second right-hand drive motor vehicle are provided. The position of the electric service battery is identical for the left-hand drive vehicle and the right-hand drive vehicle.

It is noted that the present disclosure can be applied to vehicles other than utility vehicles, such as small urban vehicles.

What is claimed is:

1. A protective structure of an electric battery in a motor vehicle having a longitudinal axis, a transverse axis, and a vertical axis, the protective structure comprising:
a support crossmember and a protector together defining a housing for accommodating the electric battery, the protector comprising at least a first defense flange configured to deform by dissipating energy under an application of a force along the longitudinal axis, the protector comprising an upper connecting strip connected at least to the first defense flange; and
at least four screwed fastenings to connect the protector to the support crossmember, the first defense flange having a first dimension along the longitudinal axis, at least 10% greater than a dimension of the electric battery along the longitudinal axis.

2. The protective structure according to claim 1, wherein the protector further comprises a second defense flange configured to deform by dissipating energy under the application of a crash force along the longitudinal axis, the first and second defense flanges framing the electric battery along the transverse axis.

3. The protective structure according to claim 2, further comprising a front plate connecting front edges of the first and second defense flanges.

4. The protective structure according to claim 1, further comprising a liquid retention tray.

5. The protective structure according to claim 4, wherein said at least four screwed fastenings fix both the protector and the liquid retention tray on the support crossmember, and/or on a vehicle body element.

6. The protective structure according to claim 1, wherein the protector is a single-piece metal sheet manufactured by cutting and folding from a thick sheet of metal, with a thickness of between 2 mm and 2.5 mm.

7. The protective structure according to claim 1, wherein a predetermined minimum distance is provided separating positive and negative terminals of the electric battery from a closest element of the protector.

8. The protective structure according to claim 1, wherein the upper connecting strip comprises attachment elements for fixing a fuse box.

9. A motor vehicle having a longitudinal axis, a transverse axis, and a vertical axis, preferably electric or hybrid, with a front overhang of less than 850 mm, the motor vehicle comprising an electric battery arranged in a front overhang area, the motor vehicle comprising the protective structure according to claim 1.

10. An assembly comprising at least a first motor vehicle according to claim 9 and a second motor vehicle according to claim 9,
wherein the first motor vehicle is a left-hand drive type and the second motor vehicle is a right-hand drive type, wherein a position of the electric battery is identical for the first and second motor vehicles.
